(19) United States
(12) Patent Application Publication
(10) Pub. No.: US 2012/0159701 A1
(43) Pub. Date: Jun. 28, 2012

(54) WATER JET ASSEMBLY WITH A SLIP RING

(75) Inventor: William J. Drury, Peachtree City, GA (US)

(73) Assignee: Custom Molded Product, Inc., Tyrone, GA (US)

(21) Appl. No.: 12/979,480

(22) Filed: Dec. 28, 2010

(51) Int. Cl. A61H 33/04; B23P 17/04

(52) U.S. Cl. 4/541.6; 29/428

(57) ABSTRACT

A water jet assembly and method for installing a water jet assembly incorporating a slip ring for a facilitating the joining of a scallop plate facing the interior water-receiving portion of a spa shell with a water jet housing on the exterior portion of a spa shell between a gasket and a scallop plate.

### BACKGROUND OF THE INVENTION

1. Field of the Invention

The present invention relates generally to a water jet assembly, and relates more specifically to a water jet assembly incorporating a slip ring for a facilitating the joining of a scallop plate facing the interior water-receiving portion of a spa shell with a water jet housing on the exterior portion of a spa shell.

2. Related Art

Conventional spas, hot tubs, whirlpool baths, swimming pools, showers and the like, hereinafter defined as hydrotherapy equipment and referred to collectively as spas, with water jets formed therein typically are constructed as a molded shell to form a water containment or fluid enclosure having a footwell or floor and an upstanding sidewall. Molded within the enclosure can be a plurality of therapy stations which may include seats or platforms for reclining. The spa shell typically is constructed of fiberglass, plastic or a similar material, or a composite of such materials.

One or more pumps usually are placed under or proximal to the spa shell to draw water from the enclosure, recirculate it, and discharge it, usually with air as an aerated water stream, into the enclosure through a plurality of nozzles or water jets of various types. The water jets usually are mounted through the spa shell in either or both of the floor and sidewall of the spa shell. Typically, water jets mounted through the sidewall are located below the maximum water line of the spa. Several water jets can be spaced about the perimeter of the artificial water structure. These water jets create jets of water to provide a massaging and therapeutic action to a human or other animal.

Spas can be preassembled, with the water jets attached to mounting holes in the spa shell. Alternatively, a spa can be purchased in an unassembled state, and the water jets can be installed into the mounting holes in the spa shell at a later time. Water jets can also be retrofitted into bathtubs or other water enclosures by creating a mounting hole in the wall of the bathtub or other water enclosure of a size and shape corresponding to the water jet equipment. After a mounting hole is fashioned to correspond to the size of the mouth of a jet housing, the water jet can be installed along with other necessary components like a pump.

The assembly and installation of a spa and related accessories must be precise in order to avoid water leakage. A conventional method of installing and sealing a water jet first requires the alignment of the mouth of a water jet housing with a mounting hole on the exterior side of a spa shell. A water jet is mounted within the water jet housing such that the water jet faces the interior of the spa. A scallop plate is then extended from the interior of the spa through the mounting hole in the spa shell. Finally, the scallop plate is screwed into place within the water jet housing to secure the water jet firmly from both sides of the spa shell. This method of installation sometimes leads to water leakage due to varying thickness in the spa shell which prevents the water jet housing and the scallop plate from reliably sealing against the spa shell.

Sealing gaskets and grommets have been used in an attempt to prevent water leakage at the edge of the mounting hole. This method involves the placement of a malleable gasket or grommet between the scallop plate and the interior side of the spa shell before the scallop plate is tightened in order to facilitate a watertight seal and to prevent leaks. As an installer screws the scallop plate into the opening in the water jet housing, the gasket, scallop plate, and interior side of the spa shell are compressed together when the threads are tightened. In theory, the flexible gasket will compensate for some variance in the cross sectional thickness of the spa shell. Although the compression of the gasket sometimes aids in the formation of a water-tight seal, it is also common for the gasket to twist and pinch as the gasket compresses. As the gasket deforms, it can become dislodged or form creases, causing water to leak from the interior of the spa through the mounting hole.

Attempts to address the problem of gasket deformation include the application of a sealant to further aid in producing a watertight contact between the gasket and both the spa shell and the scallop plate. Such methods, however, can exacerbate the problem of the gasket “walking” out of place or dislodging as the scallop plate is tightened. Further, sealants delay the pressure testing of an installed spa until the sealant has cured. In addition, the sealant can leach into the water jet and affect its performance, increasing the time and cost of the installation.

Other attempts to address the problem of gasket deformation involve the spraying of a lubricant onto the gasket, the interior spa shell, or the scallop plate. These lubricants, however, can degrade the integrity of the grommet, and can cause a dangerous, messy condition for an installer and a user of the spa, who could slip on remnants of the lubricant. Further, a lubricant must be reapplied each time the water jet is repaired, disassembled, adjusted, tightened, or reassembled. This is an additional and unnecessary step that increases the cost of a repair and again exposes individuals to a potentially hazardous condition.

Accordingly, there is a need for an improved water jet assembly and installation method to prevent water leakage. There is also a need for an improved water jet assembly and installation method that is simple, cost effective, and does not require specialized tools. There is a further need for an improved water jet assembly and installation method that does not require messy sealants or lubricants. Finally, there is a need for a water jet assembly with improved aesthetics. It is to these needs, among others, that the present invention is directed.

### BRIEF SUMMARY OF THE INVENTION

Briefly, the water jet assembly in accordance with the present invention provides a slip ring that is well suited for use with a typical spa. The slip ring in accordance with the present invention facilitates the uniform compression of a sealing gasket disposed between the spa shell and the opening of a water jet housing to provide a tighter, more reliable seal that reduces leakage. During water jet assembly and installation in accordance with the present invention, a slip ring can be added to the water jet assembly instead of spraying lubricant. The slip ring reduces the friction between the gasket and the scallop plate such that the rotation of the scallop plate does not cause the gasket to dislodge, deform or crease. Use of a slip ring does not degrade the integrity of the parts forming the water jet assembly, and does not cause a dangerous, messy condition. Further, while a lubricant must be re-applied each time the water jet assembly is disassembled, adjusted, tightened, or reassembled, a slip ring in accordance with the present invention eliminates this need. Further, the slip ring accommodates a tighter and more reliable seal between the gasket and the scallop plate than can be achieved using conventional systems. As such, the application of additional sealant or adhesive is not necessary in order to achieve a superior watertight seal.

The slip ring is a thin, flexible plate-like ring. The surface of the slip ring is smooth, and is cut to match the width of the gasket adjacent a lip in the scallop plate. Before the scallop plate is attached and screwed into the opening of the water jet housing, a slip ring is applied over the threaded neck of the scallop plate and fitted into the lip. Next, a gasket is applied over the threaded flange of the scallop plate and pressed firmly to contact the surface of the slip ring. Then, the scallop plate is screwed into place within the water jet housing, facilitated by the slip ring, such that the gasket is unaffected during the process and the watertight seal is enhanced.

A complete understanding of the present invention may be obtained by reference to the accompanying drawings, when considered in conjunction with the subsequent, detailed description of preferred embodiments in which like elements and components bear the same designations and numbering throughout the figures.

### BRIEF DESCRIPTION OF THE DRAWINGS

FIG. 1 illustrates an example of a spa having a plurality of mounting holes in the spa shell in accordance with the present invention.

FIG. 2 illustrates a perspective view of an embodiment of a water jet assembly in accordance with the present invention.

FIG. 3 is a side view of an embodiment of a water jet assembly in accordance with the present invention.

FIG. 4 is an exploded view of a water jet assembly in accordance with the present invention.

FIG. 5 is a cross-sectional view of a water jet assembly in accordance with the present invention.

### DETAILED DESCRIPTION OF PREFERRED EMBODIMENTS

The water jet assembly of the present invention comprises a water jet housing, a scallop plate, a gasket, and a slip ring. In a preferred embodiment there is provided a water jet assembly that is mounted within a mounting hole disposed on the shell of a spa. A water jet housing is mounted behind the spa shell on the side of the spa enclosure that does not receive water, in an area below the maximum water line of a filled spa. Alternatively, a specialty water jet can be mounted within a wall or within another surface capable of receiving a water jet housing such that water propelled from a jet mounted outside of the spa enclosure can be received within the spa enclosure.

A slip ring is removably mounted within a lip on the back side of a scallop plate. A gasket is then removably mounted upon the flange of a scallop plate to contact the slip ring. The scallop plate/slip ring/gasket assembly is then joined with the water jet housing through the mounting hole in the spa shell and the scallop plate is twisted into place to tighten corresponding threads. As the scallop plate is tightened, the movement of the scallop plate toward the water jet housing and the spa shell cause the gasket to contact the spa shell. As the flexible gasket is compressed between the scallop plate and the spa shell, unevenness, flaws, or variations on the surface of the spa shell are filled by the gasket and a watertight seal is created.

The slip ring disposed between the gasket and the scallop plate allows for reduced-friction contact between the inner surface of the scallop plate and the high friction surface of the gasket. This reduced-friction environment allows the inner surface of the scallop plate to glide easily relative to the surface of the gasket as the scallop plate is repeatedly rotated with applied pressure, and maintains the positioning and the integrity of the gasket. Because the gasket does not dislodge or twist or crease during the tightening process, and because the properly-placed gasket provides an enhanced waterproof seal, an installer need not apply conventional lubricants or sealer when installing the water jet assembly. Further, if a repair must be made to the water jet assembly, the scallop plate can be easily removed and again replaced without the application of a lubricant when aided by the reduction in friction provided by the slip ring.

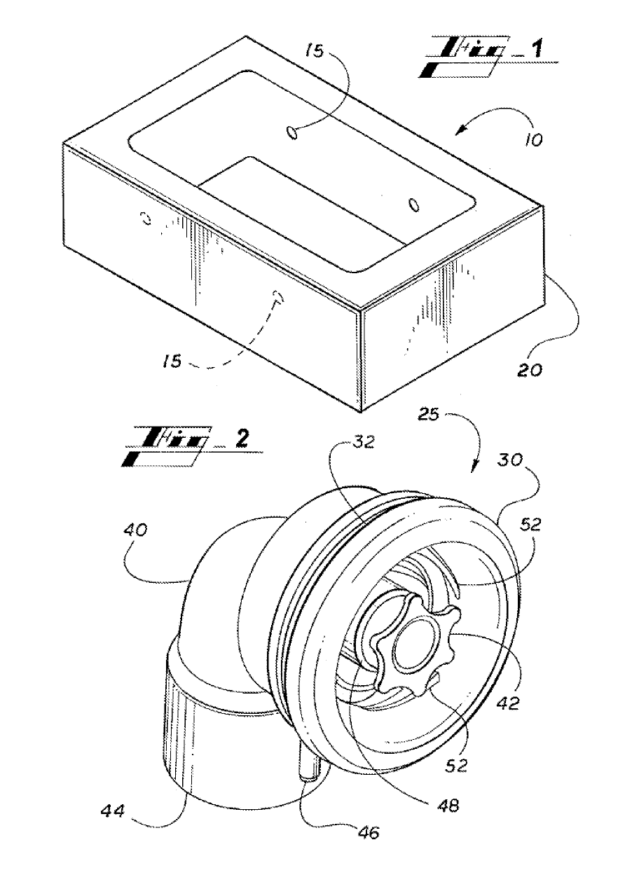

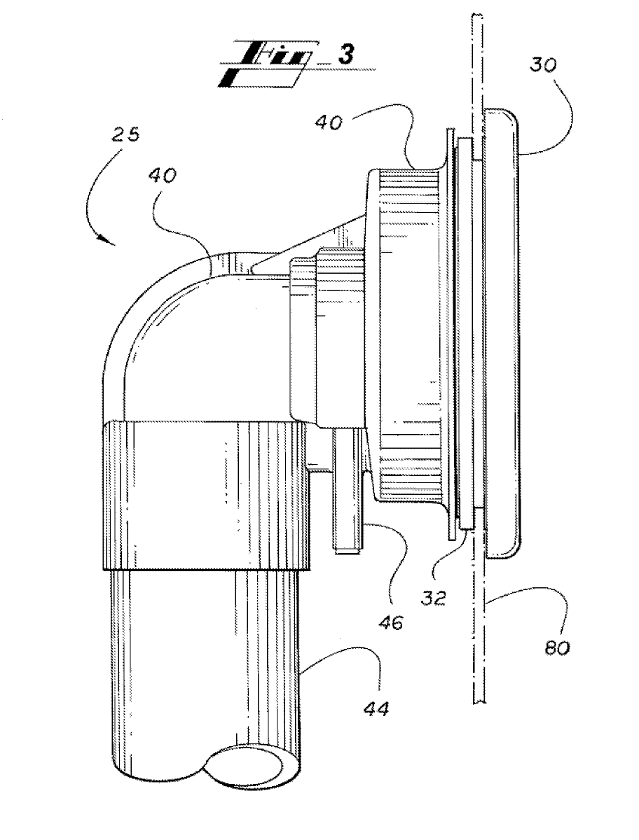

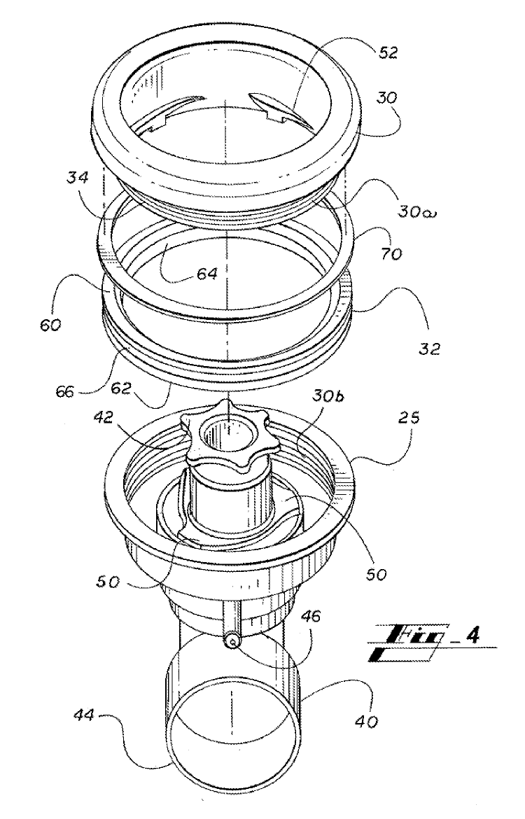

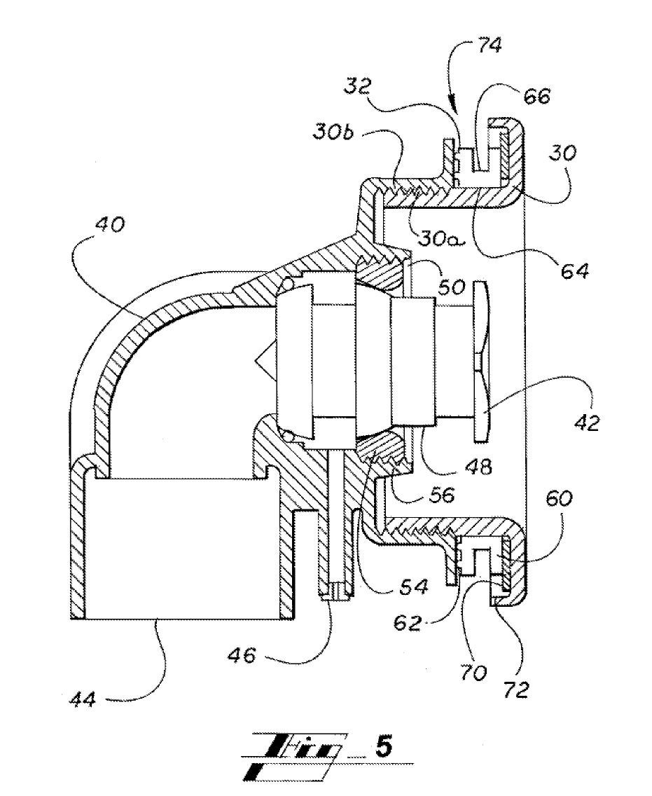

FIG. 1 illustrates an example of a spa having a plurality of mounting holes in the spa shell in accordance with the present invention. FIGS. 2-5 illustrate views of embodiments of a water jet assembly with a scallop plate, a slip ring, a gasket, and a water jet body in accordance with the present invention, specifically, with FIG. 2 showing a perspective view of an embodiment of the water jet assembly, FIG. 3 showing a side view of an embodiment of a water jet assembly, FIG. 4 showing an exploded view of a water jet assembly, and FIG. 5 showing a cross-sectional view of a water jet assembly of FIG. 3.

FIG. 1 illustrates an example of a spa 10 having a plurality of mounting holes 15 in the spa shell 20 in accordance with the present invention. A water jet assembly 25 (FIG. 2) is mounted onto the spa shell 20 through mounting hole 15. The scallop plate 30, gasket 32, and slip ring 70 (FIGS. 4 and 5) are mounted on the interior side (the side in contact with water when the spa 10 is filled) of the spa shell 20 through the mounting hole 15, while the water jet housing 40 containing the nozzle 42 is mounted on the exterior side of the spa shell 20.

FIG. 2 is an illustrative example of a spa jet assembly 25 comprising a scallop plate 30, a gasket 32, a slip ring 70 (FIGS. 4 and 5) and a water jet housing 40. A nozzle 42 is disposed inside of the water jet housing 40, and surrounded by the scallop plate 30. The water jet housing 40 has a water inlet 44 to admit water into the spa jet assembly 25, and an air inlet 46 to admit air into the spa jet assembly 25, so that water, air, or a combination of water and air are transferred into the water inside of a filled spa 10. In an exemplary embodiment, as water enters the nozzle 42 and proceeds into the interior of a spa 10, a low pressure is created within the water jet assembly 25 relative to atmosphere. Air is drawn into the water jet assembly 25 via air inlet 46 by the pressure differential, and the water stream is mixed with the air, creating an aerated water stream. The aerated water stream exits the nozzle 42 into the interior of the spa through the water jet assembly 25. When mounting the water jet assembly 25 in a spa 10, the water inlet 44 and the air inlet 46 can be disposed in any radial orientation in order to match the water inlet 44 and air inlet 46 with an appropriate air and water line accessible to the spa 10.

Water jet assembly 25 further includes a retainer 48. Retainer 48 is affixed to the nozzle 42 at a downstream end, or in an exemplary embodiment the nozzle 42 can be pivotally mounted in the retainer 48. Alternatively, the retainer 48 frictionally secures the nozzle 42 in a fixed, pivoting, or angular position relative to the direction of the water stream flowing through the nozzle 42. The retainer 48 may have two or more latching tabs 50 (FIG. 4) formed thereon for attaching the nozzle 42 to the water jet housing 40. The latching tabs 50 of the retainer 48 mate with reciprocal latching tabs 52 disposed within the scallop plate 30, or alternatively, other reciprocal latching tabs (not shown) within the water jet housing 40. Alternatively, the retainer 48 can have threads 54 or other attachment means for securing the nozzle 42 assembly to reciprocal threads 56 (FIG. 5) within the water jet housing 40.

FIG. 3 is a side view of a water jet assembly 25 in accordance with the present invention. The scallop plate 30 is attached to the water jet housing 40 and has a gasket 32 disposed between the scallop plate 30 and the water jet housing 40. The water inlet 44 is integrally formed or molded with the water jet housing 40, or in an alternative embodiment, comprises one or more pieces of tubing that can be permanently or releasably secured together to form a water line into the water jet assembly 25. The air inlet 46 is likewise either integrally formed or molded with the water jet housing 40, or can comprise an attachment for releasably or permanently securing an air line for providing air into the water jet assembly 25.

FIG. 4 is an exploded view of an embodiment of the water jet assembly 25 in accordance with the present invention. Scallop plate 30 comprises a flange 34 with scallop plate threads 30a disposed thereon. The scallop plate 30 is releasably mounted to the water jet housing 40 when scallop plate threads 30a mate and join with reciprocal scallop plate threads 30b disposed within water jet housing 40 when scallop plate 30 is twisted. The scallop plate 30 can be rotated clockwise or counterclockwise to releasably engage the water jet housing 40.

In an exemplary embodiment of a method in accordance with the present invention, the spa jet assembly 25 is attached to a spa shell 20 by aligning the water jet housing 40 and fitting the nozzle 42 within a mounting hole 15 disposed upon a spa 10 on the exterior side of the spa shell 20. Then, on the interior side of the spa shell 20, the flange 34 is extended through a mounting hole 15 in the spa shell 20, with the scallop plate 30 facing the interior, “wet side” of the spa 10. The flange 34 of the scallop plate 30 is fitted within the mounting hole 15 and contacted with the water jet housing 40. The scallop plate threads 30a of the flange 34 mate and join with the reciprocal scallop plate threads 30b when the scallop plate 30 is rotated. As the scallop plate 30 is rotated in a first direction, the scallop plate 30 and the water jet housing 40 get closer together. Likewise, as the scallop plate 30 is rotated in a first direction, the scallop plate 30 and the gasket 32 move closer to the spa shell 20. As the scallop plate 30 continues to be rotated in a first direction, the spa shell 20 is clamped between the water jet housing 40 and the scallop plate 30, with continued rotation making the seal tighter until the water jet assembly 25 is secure on the spa shell 20. When the scallop plate 30 is rotated in a second direction, conversely, the scallop plate 30 moves further away from the water jet housing 40 and further away from the spa shell 20. The width of the flange 34 allows for variance in the distance between the water jet housing 40 and the scallop plate 30 to accommodate varying spa shell 20 widths.

FIG. 5 is a cross-sectional view of an embodiment of a water jet assembly in accordance with the present invention. In this preferred embodiment, a gasket 32 is applied between the spa shell 20 and the scallop plate 30 to achieve a secure, water-tight seal. The gasket 32, which can be a grommet, a u-gasket, or another suitable deformable or compressible seal having a shape and size corresponding to both the scallop plate 30 and the mounting hole 15, increases the water-tight seal by absorbing irregularities on the surface of the spa wall and on the surface of the scallop plate 30 that may otherwise prevent a uniform compression between the spa shell 20 and the scallop plate 30.

In an alternative embodiment, the gasket 32 is a u-ring having a first face 60 and second face 62, and an inner surface 64 and outer surface 66. The first face 60 of the gasket 32 contacts the scallop plate 30, and is preferably of a lesser width than the scallop plate 30 to enhance visual appeal. The second face 62 of the gasket 32 contacts the surface of the spa shell 20, and is also preferably of a width that is less than the width of the scallop plate 30 in order to further increase visual plate 30 when the gasket 32 is applied during the installation of a spa jet assembly 35. Optionally, the second face 62 of the gasket 32 can be textured to provide additional grip or suction on a spa shell 20 when the gasket 32 is fitted over the flange 34 of the scallop plate 30 and rotated in a first direction for tightening the scallop plate 30 within the water jet housing 40.

The gasket 32 is fitted around the flange 34 of the scallop plate 30 and contacts a slip ring 70 at a first face. A slip ring 70 in accordance with the present invention is a very thin, smooth, flat ring having an outer and inner edge forming a width. The width of the slip ring 70 is preferably at least as wide as the width of the first face 60 of the gasket 32, and fits within a lip 72 (FIG. 5) of the scallop plate 30. In an exemplary method in accordance with the present invention, an installer mounts the water jet body 40 on the exterior side of a spa shell 20 adjacent a mounting hole 15 such that an opening in the water jet body 40 containing the nozzle 42 matches and extends into the mounting hole 15. After the water jet body 40 is aligned with the mounting hole 15 and water inlet 44 and air inlet 46 are properly positioned to receive corresponding water and air lines, a slip ring 70 is fitted over the scallop plate 30 and into the corresponding lip 72 such that the entire surface of the slip ring 70 is flush with the surface of the lip 72. The gasket 32 is then fitted over the flange 34 of the scallop plate 30 such that the interior surface 64 of the gasket 32 contacts the flange 34, and the first face 60 contacts the slip ring 70. The scallop plate 30, slip ring 70, and gasket 32 form a scallop assembly 74.

The scallop assembly 74 is then extended through the mounting hole 15 within the spa shell 20 from the interior, “wet side” of the spa 10 until the scallop plate threads 30a disposed on the flange 34 of the scallop plate 30 assembly meet the corresponding scallop plate threads 30b disposed on the water jet body 40. The scallop plate 30 is preferably secured to the water jet body 40 by firmly applying pressure in a substantially perpendicular direction relative to the surface of the spa shell 20 and twisting the scallop plate 30 in a first direction to interlock the scallop plate threads 30a with the corresponding scallop plate threads 30b. Pressure is applied to the scallop plate 30 during this step of the assembly in order to firmly press the second face 62 of the gasket 32 against the interior spa shell 20.

A firm connection between the spa shell 20 and the gasket 32, and between the gasket 32 and the scallop plate 30, is critical to ensure that water does not leak from the interior of the spa 10, past the scallop plate 30 and gasket 32, and through the mounting hole 15. Such pressure, however, without a means to reduce friction and facilitate smooth sliding between the surface of the lip 72 of the scallop plate 30 and the high-friction, gripping surface of the gasket 32, can cause creeping, twisting, deforming, and gaping of the gasket 32. Any of these conditions creates a potential passageway for the seepage of water through the mounting hole 15. Because a slip ring 70 having a low friction surface is placed between the lip 72 of the scallop plate 30 and the first face 60 of the gasket 32, an installer can twist the scallop plate 30 smoothly and easily while applying pressure until the scallop plate 30 is tightly screwed into the reciprocal scallop plate threads 30b of the water jet body 40. Further, because the slip ring 70 allows the lip 72 of the scallop plate 30 to glide across the first face 60 of the gasket 32 as it is rotated and secured, the gasket 32 does not creep, twist, deform, or gap during the tightening process. Also advantageously, if the scallop plate 30 must be removed in the future because, for example, the water jet assembly 10 must be repaired or replaced, an installer need not lubricate the gasket 32 or remove the gasket 32 to easily remove the scallop plate 30.

A slip ring 70 in accordance with the present invention is an integrally-formed, pressed, cut, stamped or molded, thin and low-friction ring. Preferably, the slip ring 70 is constructed from polypropylene, and its surfaces are buffed or polished in order to minimize friction of the faces of the slip ring 70 when contacted with another surface. A skilled artisan will recognize that the slip ring 70 can be made from materials such as polyvinylchloride or polyethelyne, or any other material capable of producing a resilient, low-friction surface.

Slip ring 70 can be made of any size, that is, width and thickness, such that it will function satisfactorily with different sizes of scallop plates 30. For example, there are different sized water jets and water jet bodies 40 that require different sized scallop plates 30. Producing an appropriately sized slip ring 70 so as to fit within the scallop plate 30 is a matter of design choice based on, for example but not limited to, the outer diameter of the flange 34 and the inner diameter of the lip 72. Further, the thickness of slip ring 70 can be dependent on the material of manufacture and/or on the size of the scallop plate 30. For example, a small scallop plate 30 may require a thinner slip ring 70 such that when the scallop plate 30 is attached to the water jet body 40 the scallop plate 30 does not protrude more than a desired amount into the spa 10. This situation may require a stronger yet thinner material of manufacture. Other situations may allow for a weaker yet thicker material of manufacture. The invention contemplates various sizes of slip rings 70 manufactured from various materials of manufacture.

When used in conjunction with a method in accordance with the present invention, a slip ring 70 is placed between the scallop plate 30 and the gasket 32 so that there is less friction between the scallop plate 30 and the gasket 32 when the scallop plate threads 30a and the reciprocal scallop plate threads 30b are tightened. The reduction of friction helps the gasket 32 stay in place without causing twisting, pinching, or other undesired movement.

During assembly and installation, a slip ring 70 can be added to a water jet assembly 25 instead of spraying lubricant, which can degrade the integrity of the parts forming the water jet assembly 25 and can cause a dangerous, messy condition for an installer and a user of the spa 10. Further, while lubricant must be re-applied each time the water jet assembly 25 is disassembled, adjusted, tightened, or reassembled, the slip ring 70 in accordance with the present invention eliminates this need. Further, because the slip ring 70 accommodates a tighter and more reliable seal with the gasket 32 than can be achieved using conventional systems, the application of additional sealant or adhesive is not necessary in order to achieve a satisfactory water-tight seal.

The above detailed description of the embodiments, and the examples, are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A water jet assembly comprising:
a scallop plate having a flange;
a gasket;
a slip ring disposed between said gasket and said scallop plate and removably attached about said flange; and
a water jet body.

2. The apparatus of claim 1, wherein said gasket is removably attached about said flange.

3. The apparatus of claim 1, wherein said scallop plate, said gasket, and said slip ring form a scallop assembly, and wherein said scallop assembly is removably attached to said water jet housing.

4. The apparatus of claim 1, wherein said scallop plate further comprises a lip.

5. The apparatus of claim 4, wherein said gasket has a first face and a second face, wherein said first face of said gasket contacts a first side of said slip ring, and a second side of said slip ring contacts said lip.

6. The apparatus of claim 4, wherein said second face of said gasket is textured.

7. The apparatus of claim 5, wherein said scallop plate comprises scallop plate threads disposed upon an outer surface of said flange, and said water jet housing comprises reciprocal scallop plate threads, whereby the scallop plate threads and the reciprocal scallop plate threads mate and join the scallop assembly to the water jet housing when said scallop assembly is rotated in a first direction.

8. The apparatus of claim 1, wherein said slip ring comprises a thin, flexible plate-like ring.

9. The apparatus of claim 8, wherein said slip ring further comprises a smooth or buffed surface, and wherein at least one face of said slip ring comprises a low-friction surface.

10. The apparatus of claim 5, wherein a width of said slip ring is equal to or greater than a width of the first face of said gasket.

11. The apparatus of claim 1, wherein said slip ring is made from polypropylene.

12. A water jet assembly comprising:
a scallop assembly; and
a water jet housing,
wherein said scallop assembly comprises a scallop plate having a lip, a slip ring adjacent to said lip, and a gasket adjacent to said slip ring, and wherein said water jet housing is removably attached to said scallop assembly.

13. The apparatus of claim 12, wherein said gasket has a first face and a second face, said first face contacting said slip ring, and said second face having a texture and contacting said water jet housing.

14. The apparatus of claim 12, wherein said slip ring has a width less than or equal to a width of said lip.

15. The apparatus of claim 14, wherein said slip ring has a width greater than or equal to a width of said first face of said gasket.

16. A method of assembling a water jet assembly, said method comprising:
mounting a water jet body onto an exterior side of a spa shell;
aligning an opening in the water jet body with a mounting hole in the spa shell;
fitting a slip ring about a flange of a scallop plate and into a corresponding lip of the scallop plate, wherein said slip ring is substantially flush with the surface of said lip;
fitting a gasket about the flange of the scallop plate, wherein said slip ring, scallop plate, and gasket form a scallop assembly;
extending said scallop assembly through the mounting hole within the spa shell from the interior of said spa shell until scallop plate threads disposed on said flange meet with corresponding scallop plate threads disposed said water jet body; and
twisting said scallop plate in a first direction to interlock the scallop plate threads with the corresponding scallop plate threads.

17. The method of claim 16, further comprising applying pressure during the twisting of said scallop plate in a first direction whereby said scallop plate firmly presses a second face of the gasket against the interior of the spa shell, and wherein the slip ring provides a low-friction surface to accommodate the movement of the surface of the scallop plate over a first face of the gasket.

18. The method of claim 17, wherein a width of said slip ring is greater than a width of the first face of said gasket, and less than a width of said lip.
